(19) United States
(12) Patent Application Publication
(10) Pub. No.: US 2003/0161344 A1
(43) Pub. Date: Aug. 28, 2003

(54) Method and device for transporting ethernet frames over transport SDH/SONET network

(75) Inventors: Donato Maggi, Annone di Brianza (IT); Massimiliano Rutar, Carnate (IT); Carmela Ricciardi, Parabiago (IT)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/355,132

(22) Filed: Jan. 31, 2003

(30) Foreign Application Priority Data
Feb. 22, 2002 (EP) 02290445.2
Mar. 20, 2002 (EP) 02290700.0

(51) Int. Cl. H04J 3/16

(52) U.S. Cl. 370/466; 370/395.51

(57) ABSTRACT

Disclosed is a method and network element for transporting Ethernet frames over a transport SDH/SONET network. at the sending point (AP#0), receiving a Ethernet frames to be transported through an Access Point (AP#0); mapping the Ethernet frames into a single Virtual Container (VC-X #) so that the transport of an Ethernet frame is performed by a single Virtual Container (VC); assigning a label/number to every frame; and at the receiving point (AP#1), re-ordering (FR) the received frames according to the assigned sequence label/number and outputting them through an Access Point (AP#1).

### INCORPORATION BY REFERENCE OF PRIORITY DOCUMENT

This application is based on, and claims the benefit of, European Patent Applications No. 02290445.2 filed on Feb. 22, 2002 and 02290700.0 filed on Mar. 20, 2002, which are incorporated by reference herein.

### BACKGROUND OF THE INVENTION

1. Field of the Invention

The present invention relates to the telecommunication field and in particular to a method and network element for transporting Ethernet frames over a transport SDH/SONET network.

As it is known, traffic generated by an Ethernet apparatus is characterized by discontinuities, namely there are periods with a more or less constant sending rate of Ethernet packets and periods during which a rather long time is provided between a received Ethernet frame and the next one. Such an unstable/inconstant traffic is generally termed “bursty”. On the contrary, SDH or SONET traffic is characterized by a constant sending/receiving rate. In other words, any network element of a transport SDH/SONET network sends corresponding frames with a regular and constant rate. Furthermore, Ethernet frames do not have a fixed length/size but only a maximum size (1518 bytes).

It is easy to understand that these discrepancies result in a highly difficult interfacing of two technologies having different natures/characteristics.

2. Description of the Prior Art

An already available solution to the above problem allows the mapping of Ethernet frames into SDH/SONET Virtual Containers as a transparent tributary; all incoming bits are transported to the output interface with the related timing information (frequency for recovering the proper bit rate at the reception side). Within the SDH/SONET payload also the dead times between a received Ethernet frame and the following one are mapped.

The general problem of transporting Ethernet frames over a SONET/SDH transport network is presently solved through SONET/SDH virtual concatenation. Ethernet frame transport is performed according to the following main steps: the bytes of one frame are distributed among all the available SDH/SONET Virtual Containers, namely, the first frame byte is mapped in the first VC, the second frame byte is mapped in the second VC and so on; due to the fact that SDH/SONET Virtual Containers can follow different paths, at the ending point, the Virtual Containers should be realigned; and the bytes of the Ethernet frames are extracted from the realigned Virtual Containers and the frame is finally re-assembled.

The above known procedure has the following main disadvantage: in case of failure of one SDH (or SONET) Virtual Container, the Ethernet traffic becomes completely lost; this is a consequence of the distribution of the Ethernet frame content among all the Virtual Containers, as said above. Furthermore, a failure in a basic pipeline (the single Virtual Container) leads to the failure of the complete pipe (the concatenation of all the Virtual Containers).

### SUMMARY OF THE INVENTION

In view of the above problems, the general object of the present invention is overcoming them in an efficient manner.

The main scope of the present invention is providing a method and device for an enhanced transport of Ethernet frame traffic over a transport SDH/SONET network through packet concatenation.

The above and further objects of the present invention are obtained by a method and network element according to claims 1 and 4, respectively. Further advantageous features of the present invention are set forth in respective dependent claims. All the claims are intended as an integral part of the present description.

The basic idea of the proposed solution is to assign the transport of an Ethernet frame to a single Virtual Container. This means that different Virtual Containers concurrently transport different frames (it is further stressed that through the Virtual Concatenation, all the Virtual Containers concurrently transport the same frame).

Independent basic pipelines make up the pipe and every pipeline transports a subset of Ethernet frames assigned to the complete pipe; by the Virtual Concatenation, every frame is transported by the complete pipe.

This type of concatenation has been named Packet Concatenation.

The present invention operates through a new layer/network which is provided over the SDH/SONET network in order to manage the transport of Ethernet traffic over SDH/SONET network; this new layer/network uses the resources of SDH/SONET network in such a way as to optimize the provided services and the performances with reference to this specific type of transport. Such a new layer has been fully disclosed and claimed in a previous patent application (EP02290445.2) of the same applicant of the present one. The content of it is incorporated herewith as reference.

### BRIEF DESCRIPTION OF THE DRAWINGS

The present invention will become clear in view of the following detailed description, to be read having reference to the attached sheets of drawings, wherein:

FIG. 1 shows the structure of a VPN and relating circuits and corresponds to FIG. 1 of EP02290445.2;

FIG. 2 shows a pipe comprising four Virtual Containers; and

FIG. 3 shows the two functional blocks managing the insertion and estraction of an Ethernet frame into a Virtual Container.

### BEST MODE FOR CARRYING OUT THE INVENTION

As said above, the present invention operates in a layer/network which is termed NETS (i.e. Network of Ethernet Transport over SDH/SONET) and is disclosed in EP02290445.2 which is incorporated herewith as reference. The NETS comprises basic elements that are listed below for a better comprehension of the present invention.

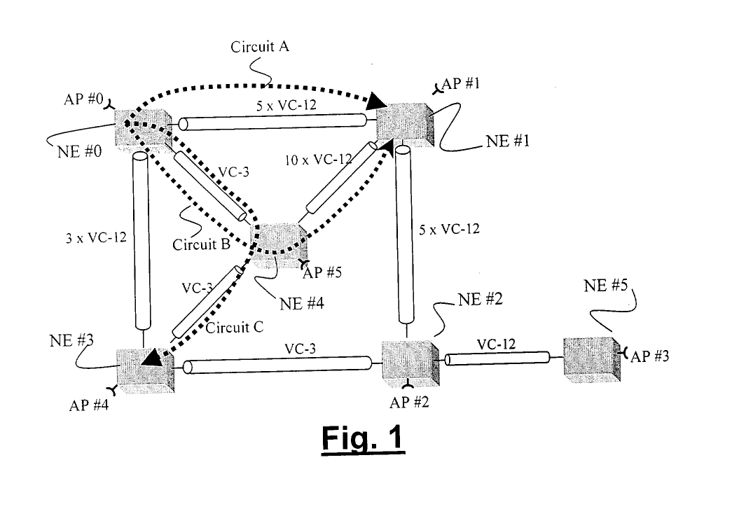

The NETS model comprises five basic elements: Access Point, Link, Circuit, Pipe and Path. An Access Point (AP) is an Ethernet interface at the boundary of an SDH/SONET network; it is the point where the Ethernet traffic can access/leave the SDH/SONET network. FIG. 1 depicts a simple example of network comprising six Network Elements (NE) with each network element having an Access Point; naturally, a Network Element can host more than one Access Point.

A pair of Ethernet Access Points defines a point to point connection; this connection is named Link. For instance, with reference to FIG. 1, the pair AP #0 & AP #1 identifies a link; the couple AP #2 & AP #5 defines another link, and so on.

An SDH/SONET network could allow for the connection of two Access Points (i.e. to accomplish a Link) by means of different routes; every route is named Circuit. A Circuit is obtained by a Pipe concatenation and could be considered as a series connection of N Pipes.

In its turn, every Circuit/route that connects two Access Points can be divided into a sequence of smaller segments; every segment is named Pipe.

The basic pipeline is the Virtual Container that connects two Network Elements; it is named Path.

FIG. 2 depicts a pipe connecting Access Points AP#0 and AP#1 (at NE#0 and NE#1, respectively), the pipe comprising four Virtual Containers, namely VC-X#1 to VC-X#4. For instance, the VCs of the pipe could be VC-4 or VC-12 (please note that the pipe of FIG. 2 does not correspond exactly to the one of FIG. 1).

At NE#0, the Ethernet frames incoming through AP#0 are stored into a queue buffer Q_{IN}; let consider a sequence of frames (not shown) labelled as A, B, C, D, E, etc . . .

The output of incoming Ethernet frame queue buffer Q_{IN} is provided to a frame dispatcher FD assigning a frame to every Virtual Container. For instance, frame A is assigned to VC-X #1, frame B to VC-X #2, frame C to VC-X #3 and frame D to VC-X #4. During such an assignment operation, a sequence label/number is attached to every frame.

Every Virtual Container (VC-X#1 to VC-X#4) of the pipe performs the transport of the assigned Ethernet frame to the end Network Element NE#1 but, due to the fact that different Virtual Containers along different paths concurrently transport different frames, at the ending point, the received frames must be re-ordered so that the original sequence is obtained. Such a re-ordering is done at a frame re-ordering block (FR) by using the label/number that was attached thereto at NE#0.

At the ending network element NE#1, the frame re-ordering block FR is thus provided for re-arranging the sequence of received frames in a correct manner. The output of the frame re-ordering block is fed to a buffer of outgoing frames Q_{OUT}. For instance, we consider that the sequence of frames received at the ending point is B, D, A and C. In this case, only after receiving frame A, both frames A and B can be stored in the outgoing frame queue buffer Q_{OUT} to be transmitted. Analogously, only after the reception of frame C also frames C and D can be stored in the same queue to be transmitted as output.

At the transmission side (NE#0), the next frame of the queue of incoming frames will be assigned to one of the four Virtual Containers. For instance, it could be assigned to the first VC that has completed the transport of currently assigned frame. The same will be made for the following incoming Ethernet frames that will be transported by respective available VC. At the receiving side, the received frames are re-ordered and stored in the outgoing frame queue buffer Q_{OUT} for the output thereof through the Access Point AP #1.

In the above example, the criterion of assignment of a frame to a VC is very simple: a frame is assigned to the first available VC. Obviously, more complex and efficient criteria can be used. It should be noticed that the assignment criterion does not affect the basic idea of this new type of concatenation.

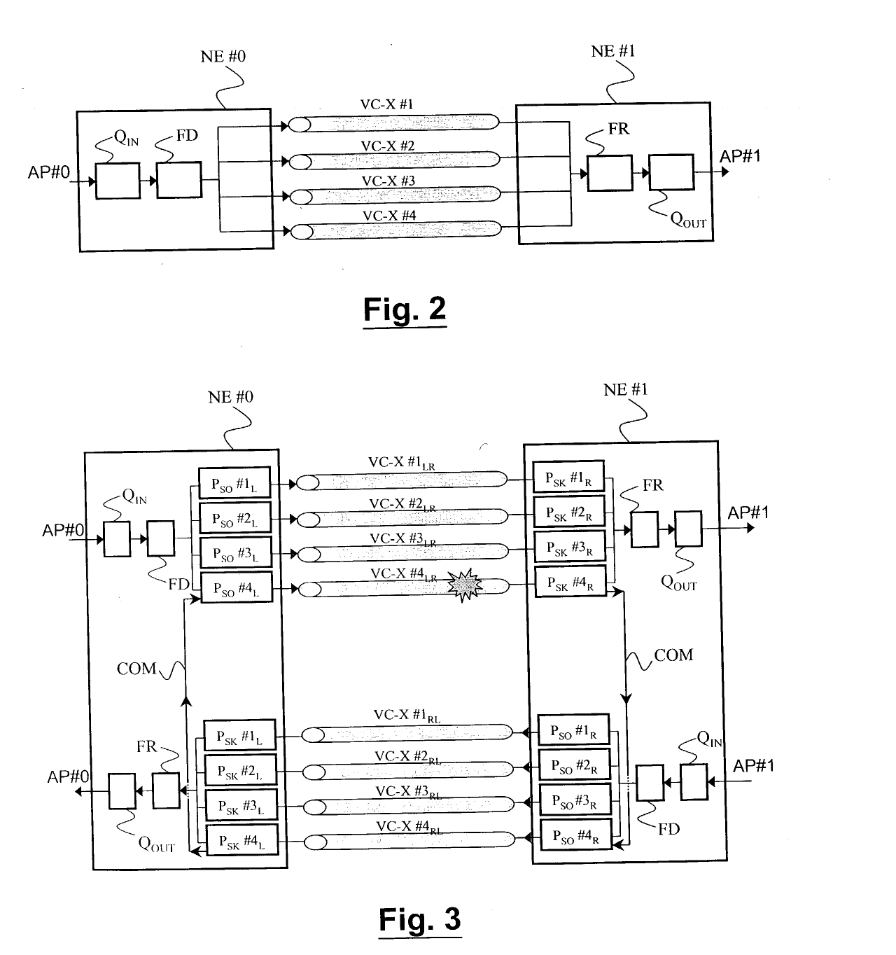

Advantageously, according to the present invention (see FIG. 3), in case of failure of a Virtual Container (e.g. VC-X #4), it can be removed from the pipe and the remaining Virtual Containers (VC-X #1, VC-X #2 and VC-X #3) perform the Packet Concatenation with reduced resources.

Thus, a failure on a basic pipeline does not result in the complete loss of the traffic but just in a bandwidth reduction.

There now follow an exemplifying description of how the removal of a failed Virtual Container is performed.

FIG. 3 depicts the pipe of FIG. 2 in a more detailed manner in order to show the two functional blocks that manage the insertion and extraction of an Ethernet frame into a Virtual Container. The blocks are named Path source P_{SO} and Path sink P_{SK} blocks, respectively. The “L” suffix of blocks of Network Element NE#0 stands for left; analogously, the “R” suffix of blocks of Network Element NE#1 stands for right.

Let consider as an example a failure occurred on VC-X #4_{LR} (namely, from NE #0 to NE #1). Path sink P_{SK} #4_{R} detects the failure as it does not receive any frame and provides the related failure information to Path source P_{SO} #4_{R} through a communication channel COM; the transmission of Ethernet frames on VC-X #4_{RL} is disabled and just status information are forwarded to Path sink P_{SK} #4_{L} by means of the VC-X #4_{RL} itself.

The failure information is received by Path sink P_{SK} #4_{L} and forwarded to Path source P_{SO} #4_{L} that in its turn disables the transmission of Ethernet frames; at this moment the VC-X #4 is completely disabled in both directions and this condition will stay until the disappearance of failure detection.

In the above example the pipe dimension is dynamically modified in order to recover from a failure. The dynamic modification of the pipe dimension can be performed also in absence of failure just to increase/decrease the pipe capability; this feature is performed by the same communication channel already described and without any loss of Ethernet frames.

The management of the communication channel for dynamic sizing of the pipe is not further disclosed in this application.

As already described, the present invention results in two main advantages:

in case of failure of one Virtual Container the bandwidth is reduced but the traffic is not completely lost; and

a dynamic modification of the pipe dimension without any traffic loss is possible.

There have thus been shown and described a novel method and a novel network element which fulfill all the objects and advantages sought therefor. Many changes, modifications, variations and other uses and applications of the subject invention will, however, become apparent to those skilled in the art after considering the specification and the accompanying drawings which disclose preferred embodiments thereof. All such changes, modifications, variations and other uses and applications which do not depart from the spirit and scope of the invention are deemed to be covered by the invention which is limited only by the claims which follow.

What is claimed is:

1. A method for transporting an Ethernet signal through a pipe from a sending point to a receiving point over at least one SDH/SONET network, the at least one SDH/SONET network comprising network elements or nodes, fiber connections connecting the network elements and SDH/SONET virtual containers, the transport being managed through a new layer over SDH/SONET network physical layer, the new layer comprising Access Points, links of Access Point pairs and circuits, namely the possible routes for connecting a pair of Access Points, the method comprising the steps of:
at the sending point, receiving a Ethernet frames to be transported through an Access Point; mapping the Ethernet frames into a single Virtual Container so that the transport of an Ethernet frame is performed by a single Virtual Container; assigning a label/number to every frame; and
at the receiving point, re-ordering the received frames according to the assigned sequence label/number and outputting them through an Access Point.

2. A method according to claim 1, wherein it further comprises, at the sending point, the step of storing the Ethernet frames to be transmitted into an incoming frame queue buffer, and, at the receiving point, the step of storing the received Ethernet frames into an outcoming frame queue buffer.

3. A method according to claim 1 or 2, wherein, in case of failure of a Virtual Container, communicating the failure information to the sending point so that it disables the transmission of Ethernet frames until the failure is restored, the pipe bandwidth being dynamically modified.

4. A Network Element of a SDH/SONET network able to transport an Ethernet signal through a pipe from a sending point to a receiving point, the SDH/SONET network comprising further network elements, fiber connections connecting the network elements and SDH/SONET virtual containers, the transport being managed through a new layer over SDH/SONET network physical layer, the new layer comprising Access Points, links of Access Point pairs and circuits, namely the possible routes for connecting a pair of Access Points, wherein it comprises:
a mapper and scheduler (FD) for mapping a received Ethernet frame into a single Virtual Container so that the transport of an Ethernet frame is performed by a single Virtual Container;
an assignor of a label/number to every frame; and
a re-orderer of the received frames according to the assigned sequence label/number.

5. A Network element according to claim 4, wherein it further comprises an incoming frame queue buffer for storing the received Ethernet frames to be transmitted and an outcoming frame queue buffer for storing the received Ethernet frames before the output thereof through a proper Access Point.

6. A Network element according to claim 4 or 5, wherein it further comprises a communication channel for communicating, in case of failure of a Virtual Container, failure information to the sending point so that it disables the transmission of Ethernet frames until the failure is restored, the pipe bandwidth being dynamically modified.
